(19) United States
(12) Patent Application Publication
(10) Pub. No.: US 2026/0236762 A1
(43) Pub. Date: Aug. 13, 2026

(54) Anomaly Identification and Resolution Using Neuromorphic Computing

(71) Applicant: Bank of America Corporation, Charlotte, NC (US)

(72) Inventors: Adam King, Fort Mill, SC (US); Nicola Stockton, Chester, NC (US); James Stefan Corday, Northwich (GB); Alec Tenne, Belmont, NC (US)

(21) Appl. No.: 19/052,728

(22) Filed: Feb. 13, 2025

(51) Int. Cl. G06N 3/08

(52) U.S. Cl. CPC G06N 3/08

(57) ABSTRACT

Arrangements for identifying and resolving anomalies are provided. A computing platform may train a spiking neural network. The computing platform may monitor interaction information associated with one or more computing devices. The computing platform may analyze the interaction information using one or more preconfigured rules. The computing platform may trigger a security identification process. The computing platform may identify and execute an action based on triggering the security identification process.

### BACKGROUND

In some instances, bad actors may attempt to interact with devices within an enterprise system, using, for example, social engineering and/or cognitive manipulation tactics. Currently, such anomalies may be difficult to identify and resolve while minimizing excess computing resources, due to the large volume of interaction information associated with large-scale enterprise systems. Accordingly, it may be advantageous to identify more improved methods and systems for identifying and resolving such anomalies.

### SUMMARY

Aspects of the disclosure provide effective, efficient, scalable, and convenient solutions that address and overcome the technical problems associated with identifying and resolving anomalies using neuromorphic computing. In accordance with one or more aspects, a computing platform with at least one processor, a communication interface communicatively coupled to the at least one processor, and memory storing computer-readable instructions may train, based on historical information, a machine learning model, in which training the machine learning model may configure the machine learning model to trigger and apply a security identification process. The computing platform may monitor a plurality of computing devices to detect interaction information. The computing platform may analyze using a plurality of preconfigured rules of the machine learning model, the interaction information to detect whether or not any of the plurality of preconfigured rules may be violated. The computing platform may, based on detecting that one of the plurality of preconfigured rules is violated more than a threshold amount of times, trigger a security identification process of the machine learning model, in which triggering the security identification process may include using the machine learning model to identify an action to perform based on the one of the plurality of preconfigured rules and the interaction information. The computing platform may execute the action by sending one or more commands, to one or more of the plurality of computing devices, that when received, may direct the one or more of the plurality of computing devices to execute the action to address malicious activity associated with the interaction information.

In one or more example, the machine learning model may be a spiking neural network that may utilize one or more neuromorphic processors. In some instances, the one or more preconfigured rules may further include a first rule based on comparing an email address of a source device to an expected email address, a second rule based on comparing internet protocol (IP) addresses of a plurality of source devices, and a third rule based on comparing a time of existence of one or more user accounts to an expected time of existence.

In some instances, the action may further include identifying a proper team to further analyze the anomaly, and sending an alert to the proper team. In one or more example, the action may further include blocking one or more malicious devices associated with the interaction information. In some instances, the action may further include sending commands that direct a user account associated with the interaction information to temporarily pause access to the user account.

In one or more examples, the plurality of computing devices comprises one or more of a back end server system, a local branch, or a user device. In some instances, the computing platform may update, using a dynamic feedback loop and based on the monitoring, the analyzing, and the triggering, the machine learning model.

In some instances, the computing platform may generate a report, in which the report comprises the interaction information that caused an anomaly associated with the interaction information, and an action that was executed to resolve the anomaly. In one or more examples, the computing platform may send, to an enterprise administrative device, the report and one or more commands directing the enterprise administrative device to display the report, which may cause the enterprise administrative device to display the report.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for identifying and resolving anomalies using neuromorphic computing in accordance with one or more example aspects described herein;

FIGS. 2A-2D depicts an illustrative event sequence for identifying and resolving anomalies using neuromorphic computing in accordance with one or more aspects described herein;

FIG. 3 depicts an illustrative method for identifying and resolving anomalies using neuromorphic computing in accordance with one or more aspects described herein;

FIG. 4 depicts an illustrative graphical user interface for identifying and resolving anomalies using neuromorphic computing in accordance with one or more aspects described herein; and

FIGS. 5A-5B depict additional illustrative graphical user interfaces for identifying and resolving anomalies using neuromorphic computing in accordance with one or more aspects described herein.

### DETAILED DESCRIPTION

In the following description of various illustrative aspects, reference is made to the accompanying drawings, which form a part hereof, and in which is shown, by way of illustration, various aspects of the disclosure may be practiced. In some instances, other aspects may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction, one or more aspects of the disclosure relate to identifying and resolving anomalies using neuromorphic computing. Currently, companies or institutions, including banks, are increasingly targeted by cognitive security threats that manipulate human behavior and perceptions. These threats, such as social engineering attacks, disinformation, and psychological operations, may affect both customers and employees, which may reduce security and lead to damage to technical infrastructure. Traditional cybersecurity systems may protect information and systems but may be inadequate at detecting and countering cognitive threats. A more sophisticated approach, configured for adaptation and pattern recognition, may be necessary to increase security for customers, vendors, and/or employees to reduce such potential issues.

Accordingly, a system may leverage neuromorphic computing architectures, using, for example, spiking neural networks (SNNs), which may enhance cognitive security for various institutions, such as financial institutions. Neuromorphic computing mimics neural pathways, which may enable real-time detection of disinformation and other cognitive manipulations targeting customers, employees, and vendors. By replicating synaptic connectivity and plasticity, this system may continuously adapt to evolving security threats and cognitive vulnerabilities within various industries.

Accordingly, this system may be designed to perform pattern recognition, anomaly detection, and contextual analysis across vast streams of information such as financial information, communications, and behavioral information. The system may effectively counter sophisticated threats such as phishing, synthetic identity deceit, and disinformation campaigns by learning from its environment and may additionally continuously adjust associated threat detection algorithms. In some cases, the system may ensure transparency through explainable artificial intelligence (XAI), which may provide detailed, understandable explanations of its threat detection and decision-making processes.

Accordingly, the system may utilize neuromorphic computing architecture for cognitive security. For example, technology associated with the system may include neuromorphic hardware that may use SNNs, which may simulate one or more event-driven processes. This technology may be used to detect and adapt to emerging patterns and anomalies, which may enable the system to monitor communication and data for signs of anomalies, disinformation, and malicious tactics. In some cases, neuromorphic processors may handle massive amounts of data in parallel, detecting and processing cognitive security threats by simulating synaptic changes as new information flows into the system. In a financial context, for example, this may involve (based on, e.g., a corresponding user opting into such a system) monitoring interaction information such as transactions, vendor interactions, and internal communications for signs of manipulation or coordinated attacks. As an example, the system may identify a pattern where phishing attempts increase dramatically during loan application processes, and in response, the system may automatically adjust an associated detection model to flag and prevent similar future attempts.

Accordingly, the system may utilize SNNs for cognitive pattern detection. For example, a SNN may be a machine learning model optimized to detect subtle, event-driven patterns in real time. A SNN may function to detect patterns in behavior, data, and communication channels to identify attempts to create anomalous activity, such as disinformation spread or social engineering. In some cases, information may flow from various communications (e.g., customer service, email, etc, that a user opts into and allows) and, for example, financial transactions, which may be analyzed by the SNN to detect coordinated behavior or manipulation. In some cases, a SNN may identify timing and sequence anomalies in interactions that traditional rule-based systems might miss. As an example, a group of accounts connected through multiple transactions may begin manipulating stocks using misinformation. The SNN may identify this anomaly to prevent further damage by blocking those accounts.

Accordingly, the system may utilize real-time cognitive security monitoring, including, for example, technology such as neuromorphic processors with continuous monitoring and feedback loops, which may analyze customer interactions and financial data streams. In some cases, the system may monitor (to the extent a user opts in) customer interactions, online consumer activities, vendor transactions, and employee communications in real time, flagging cognitive security threats like social engineering or synthetic identity deceit. In some cases, SNNs may continuously process inputs, such as communication data, transaction logs, and user behavior patterns. Real-time anomaly detection may enable immediate responses to cognitive attacks, ensuring the swift neutralization of threats before they escalate. As an example, a sudden spike in suspicious customer activity, such as multiple loan applications from synthetic identities, may be detected and flagged, preventing issues before any disbursements occur.

Accordingly, the system may utilize adaptive learning for long-term cognitive security. For example, adaptive learning algorithms may be used to continuously evolve based on threat data and feedback from past incidents. In some cases, the system may dynamically reconfigure itself, learning from cognitive threats to improve its future detection capabilities. The system may automatically adjust to new disinformation or deceptive tactics targeting. The system may further include adaptive learning models which may allow the system to modify its detection rules based on new forms of manipulation, such as phishing attempts or unauthorized investment schemes. The system may continually update itself without needing manual retraining, which may make the system highly scalable and efficient. For example, the system may learn from a phishing attack targeting employee credentials and adjusts its detection rules to identify future attempts based on changes in email patterns or metadata.

Accordingly, the system may utilize neuromorphic-based explainable cognitive security (XCS). For example, neuromorphic processors may be integrated with explainable artificial intelligence (XAI) provide transparent insights into how threats were identified and why specific actions were taken. The system may offer clear, understandable explanations of detected cognitive security threats, allowing institutional security teams to adjust the system's performance as necessary. As an example, the neuromorphic processors may analyze cognitive security data and provide a detailed report explaining why particular patterns were flagged as issues such as disinformation. This may ensure that security teams may trace the decision-making process back to the root causes and implement necessary interventions. As another example, a report may explain that many synthetic accounts were detected and blocked based on anomalies in their behavior and patterns.

These and other features are described in further detail below.

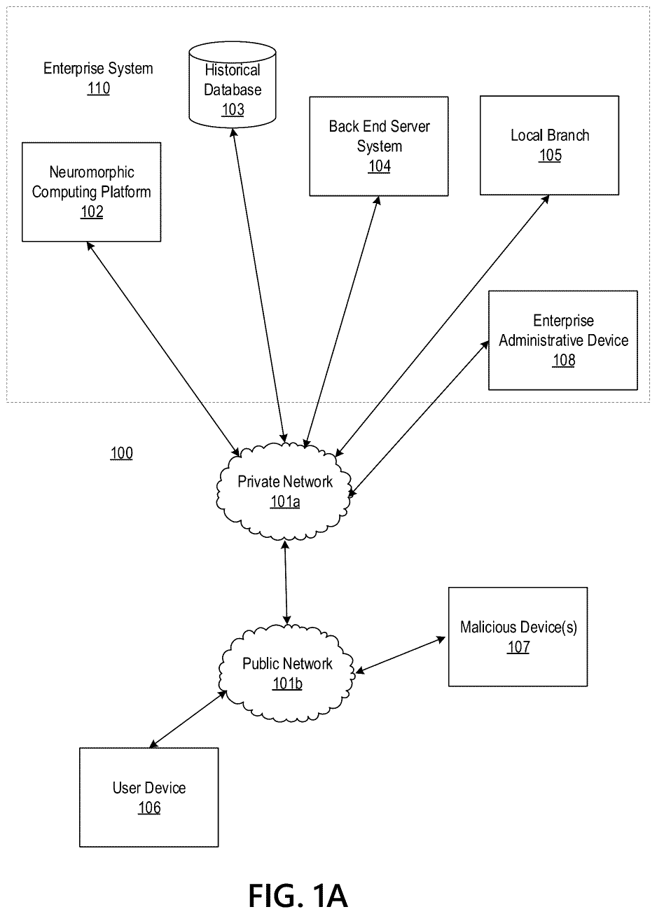

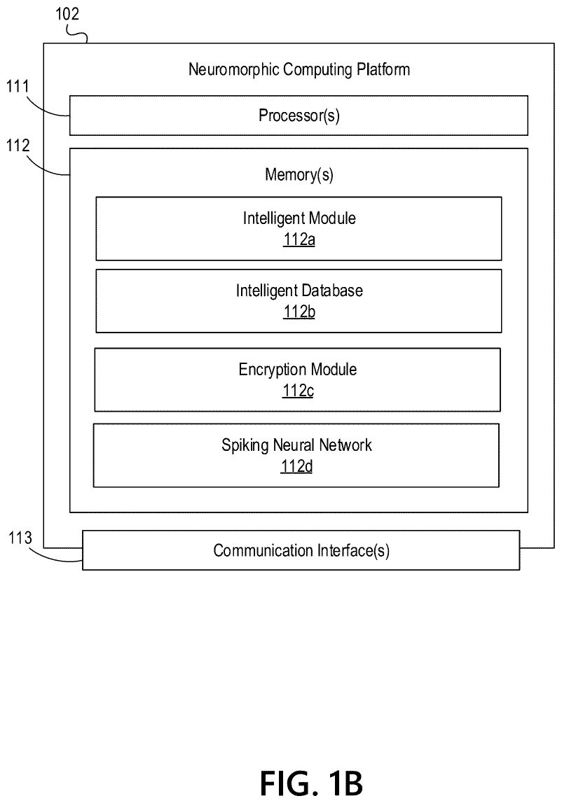

FIGS. 1A-1B depict an illustrative computing environment for identifying and resolving anomalies using neuromorphic computing in accordance with one or more example aspects described herein. Referring to FIG. 1A, computing environment 100 may include one or more computer systems connected through one or more networks. For example, computing environment 100 may include neuromorphic computing platform 102, historical database 103, back end server system 104, local branch 105, user device 106, malicious device(s) 107, and enterprise administrative device 108. While the illustration of FIG. 1A includes particular numbers of devices, any number of systems or devices may be used without departing from the aspects described herein.

As mentioned above, computing environment 100 also may include one or more networks, which may interconnect one or more of neuromorphic computing platform 102, historical database 103, back end server system 104, local branch 105, user device 106, malicious device(s) 107, and/or enterprise administrative device 108. For example, computing environment 100 may include private network 101a and public network 101b. In some instances, private network 101a and/or public network 101b may include one or more sub-networks (e.g., Local Area Networks (LANs), Wide Area Networks (WANs), or the like). In some instances, private network 101a may be associated with a particular user, location (e.g., home, office), and/or organization (e.g., a corporation, financial institution, educational institution, governmental institution, or the like), and may interconnect one or more computing devices associated with the user, location and/or organization.

According to one or more aspects, one or more devices within the private network 101a may form a sub-network (e.g., enterprise system 110). In FIG. 1A, neuromorphic computing platform 102, historical database 103, back end server system 104, local branch 105, and enterprise administrative device 108 may collectively form a sub-network of devices. Although not shown, user device 106 may additionally or alternatively be part of enterprise system 110 and connect to private network 101a without departing from the scope of the disclosure. For example, enterprise system 110 may be a sub-network that represents an organization (e.g., a corporation, financial institution, educational institution, governmental institution, or the like). Devices in enterprise system 110 may communicate with one another using private network 101a and/or public network 101b.

As described further below, neuromorphic computing platform 102, may be a computer system that includes one or more computing devices (e.g., servers, server blades, or the like) and/or other computer components (e.g., processors, memories, communication interfaces) that may be used to train, host, and/or otherwise refine machine learning model, such as a SNN which may be used to identify and/or analyze anomalies based on interaction information from one or more source devices (e.g., back end server system 104, local branch 105, user device 106, and/or malicious device(s)), execute actions to resolve such anomalies, and/or perform other functions. In some instances, neuromorphic computing platform 102 may be in a centralized location. Alternatively, neuromorphic computing platform 102 may utilize a distributed computing environment in which one or more nodes are distributed across one or more devices (e.g., back end server system 104, local branch 105, and/or user device 106), and neuromorphic computing platform 102 may be configured to perform the functions described herein in a decentralized manner.

Historical database 103 may include one or more computing devices and/or other computer components (e.g., processors, memories, communication interfaces). In some instances, historical database 103 may include one or more data sources that may store historical social engineering attacks and historical disinformation, which may be used by neuromorphic computing platform 102, in furtherance of training the spiking neural network. In some instances, historical database 103 may be configured as a cloud storage system, in which historical database 103 may be a cloud computing model that stores information on the Internet through a cloud computing provider who manages and operates historical database 103 as a service. In some instances, historical database 103 may be local or non-cloud based storage, or may support cloud based storage.

Back end server system 104 may be a computer system that includes one or more computing devices (e.g., servers, server blades, or the like) and/or other computer components (e.g., processors, memories, communication interfaces) that may be used to process information related to back-end, information technology (IT) infrastructure associated with the enterprise system 110, and/or perform other functions. In some instances, back end server system 104 may represent a data center in a particular geographic location. In some cases, back end server system 104 may be one or more servers distributed throughout a geographic region without departing from the scope of the disclosure.

Local branch 105 may be one or more local offices associated with enterprise system 110, such as, for example, branches associated with a financial institution. Local branch 105 may include one or more automated teller machines (ATMs), which may be used to process checks and/or access account information associated with a user. Local branch 105 may additionally be in communication with back end server system 104, neuromorphic computing platform 102, and/or other devices within enterprise system 110 using private network 101a, without departing from the scope of the disclosure. In some instances, anomalies associated with local branch 105 may be detected by neuromorphic computing platform 102, for example, interaction information with malicious device(s) 107, as discussed in more detail below.

User device 106 may be a laptop computer, desktop computer, mobile device, tablet, smartphone, and/or other device, which may represent, for example, a user outside of enterprise system 110 (or in some cases, and although not shown, within enterprise system 110). In some instances, user device 106 may be a user computing device that is used by an individual. In some instances, user device 106 may be configured to utilize services associated with enterprise system 110 (e.g., services associated with an account of a user of user device 106), and/or perform other functions.

Malicious device(s) 107 may be one or more computing devices associated with an individual or entity that is currently operating outside of private network 101a. In some instances, malicious device(s) 107 may be a source of a social engineering attack, cognitive manipulation tactic, and may connect to user device 106 via the public network 101b. In some instances, malicious device(s) 107 may interact with devices within enterprise system 110, such as back end server system 104, and/or local branch 105, which may be detected by neuromorphic computing platform 102, as discussed in more detail below.

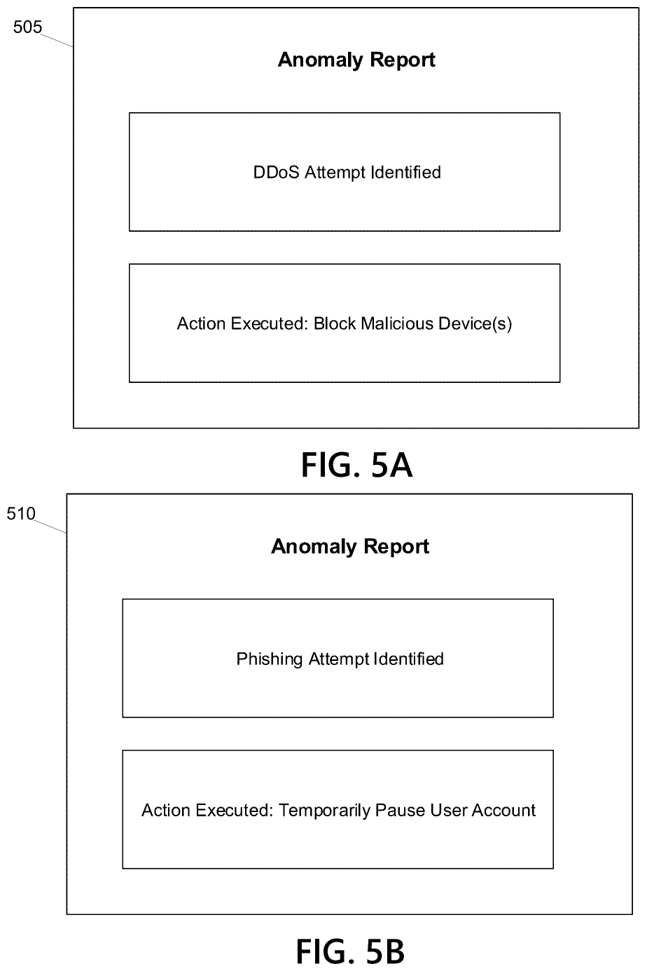

Enterprise administrative device 108 may be a laptop computer, desktop computer, mobile device, tablet, smartphone, and/or other device, which may represent, for example, computing device that is used by an administrator within enterprise system 110. In some instances, enterprise administrative device 108 may be configured to display one or more user interfaces (e.g., interfaces depicting an anomaly report, such as what is shown by FIGS. 5A and/or 5B, or the like).

In one or more arrangements, neuromorphic computing platform 102, historical database 103, back end server system 104, local branch 105, user device 106, malicious device(s) 107, and enterprise administrative device 108 may be any type of computing device capable of sending and/or receiving requests and processing the requests accordingly. For example, neuromorphic computing platform 102, historical database 103, back end server system 104, local branch 105, user device 106, malicious device(s) 107, enterprise administrative device 108, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of neuromorphic computing platform 102, historical database 103, back end server system 104, local branch 105, user device 106, malicious device(s) 107, and enterprise administrative device 108 may, in some instances, be special-purpose computing devices configured to perform specific functions.

Referring to FIG. 1B, neuromorphic computing platform 102 may include one or more processors 111, memory 112, and communication interface 113. A data bus may interconnect processor 111, memory 112, and communication interface 113. Communication interface 113 may be a network interface configured to support communication between neuromorphic computing platform 102 and one or more networks (e.g., private network 101a, public network 101b, or the like). Memory 112 may include one or more program modules having instructions that when executed by processor 111 cause neuromorphic computing platform 102 to perform one or more functions described herein and/or one or more databases that may store and/or otherwise maintain information which may be used by such program modules and/or processor 111. Processors 111 may comprise one or more neuromorphic processors, which may be used in furtherance of performing one or more of the functions described herein.

In some instances, the one or more program modules and/or databases may be stored by and/or maintained in different memory units of neuromorphic computing platform 102 and/or by different computing devices that may form and/or otherwise make up neuromorphic computing platform 102. For example, memory 112 may have, host, store, and/or include intelligent module 112a, intelligent database 112b, encryption module 112c, and/or spiking neural network 112d. Intelligent module 112a may have instructions that direct and/or cause neuromorphic computing platform 102 to receive historical information, train a spiking neural network, identify and/or resolve anomalies, and/or perform other functions, as discussed in greater detail below. Intelligent database 112b may store information used by intelligent module 112a and/or neuromorphic computing platform 102 in application of advanced techniques to identify and resolve anomalies, and/or in performing other functions. Encryption module 112c may be configured to encrypt and/or decrypt information received by neuromorphic computing platform 102, using, for example, homomorphic encryption, and/or perform other functions. Spiking neural network 112d may be used by neuromorphic computing platform 102 and/or intelligent module 112a to train, refine and/or otherwise update methods for identifying and resolving anomalies using neuromorphic computing hardware, and/or perform other methods described herein.

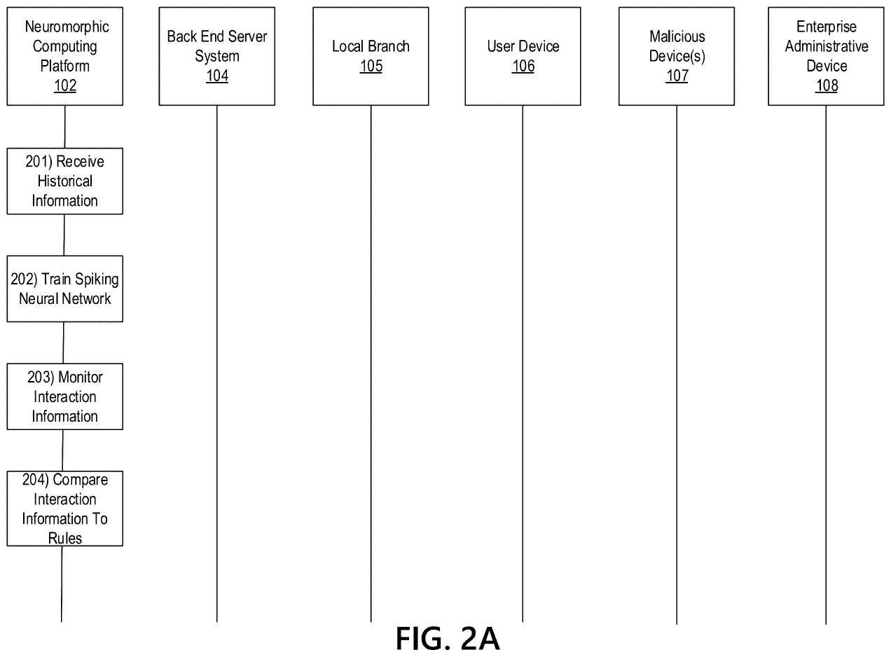

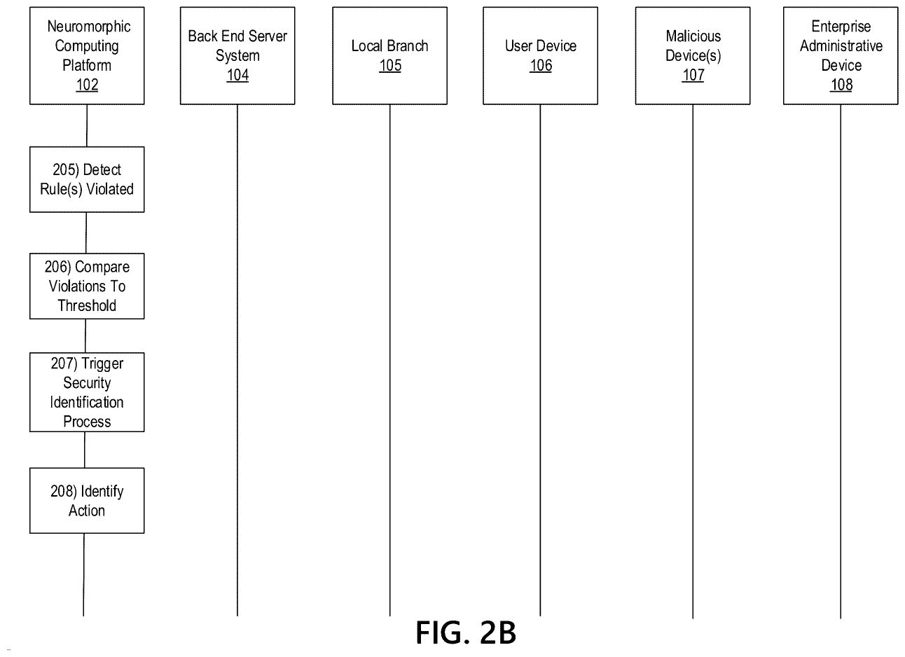

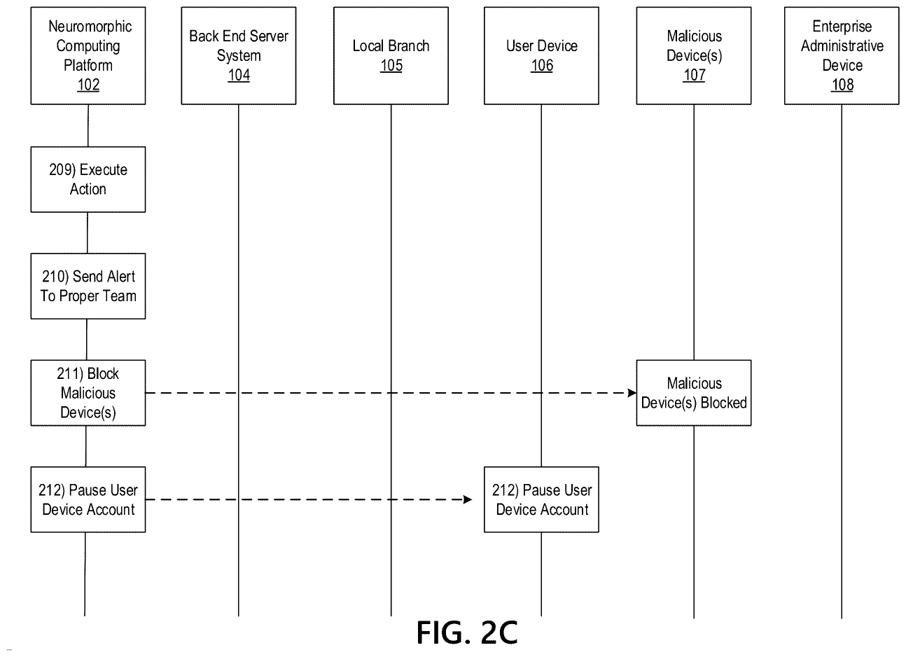

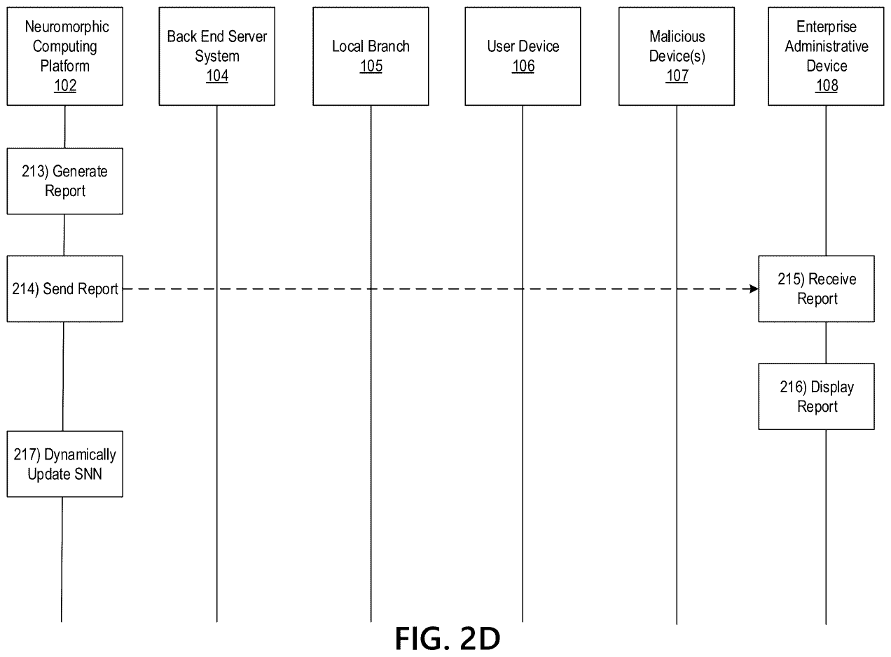

FIGS. 2A-2D depicts an illustrative event sequence for identifying and resolving anomalies using neuromorphic computing in accordance with one or more aspects described herein. Referring to FIG. 2A, at step 201, neuromorphic computing platform 102 may receive historical information. For example, neuromorphic computing platform 102 may receive the historical information from historical database 103 and via private network 101a. For example, historical information may include historical phishing attempts, historical attacks on infrastructure using techniques such a distributed denial-of-service (DDoS) attack, historical identity deceit, historical disinformation/social manipulation tactics, etc.

At step 202, neuromorphic computing platform 102 may train a spiking neural network (e.g., spiking neural network 112d) using the historical information that was received at step 201. In some instance, the information used to train the spiking neural network may be encrypted using homomorphic encryption, in order to maintain privacy. In some instances, the spiking neural network may utilize supervised learning, in which labeled datasets may be inputted into the spiking neural network, which may be used to train the spiking neural network to perform the functions described below. Using labeled inputs and outputs, the spiking neural network may measure its accuracy and learn over time. As another example, supervised learning techniques such as linear regression, classification, neural networking, and/or other supervised learning techniques may be used. Additionally or alternatively, techniques such as natural language processing (NLP) and/or optical character recognition (OCR) may be used to interpret visual and/or linguistic information associated with the historical information. In some instances, the spiking neural network may utilize unsupervised learning, in which unlabeled data may be input into the spiking neural network. For example, unsupervised learning techniques such as k-means, gaussian mixture models, frequent pattern growth, and/or other unsupervised learning techniques may be used. In some instances, the spiking neural network may be a combination of supervised and unsupervised learning.

In training the spiking neural network, neuromorphic computing platform 102 may train the spiking neural network to configure one or more rules, that neuromorphic computing platform 102 may use to detect rule violations based on received interaction information. If neuromorphic computing platform 102 detects that the threshold has been exceeded for any given rule, neuromorphic computing platform 102 may trigger a security identification process using the spiking neural network to further analyze the interaction information and identify an action to resolve an anomaly associated with the interaction information, as discussed in more detail below.

In this manner, the security identification process may only be triggered by neuromorphic computing platform 102 when certain conditions are met (e.g., interaction information that has caused a threshold based on one or more rules being violated to be exceeded), similar to neural impulses being triggered for response when a particular event triggers a response. This may realize the technical benefit of low-power consumption and significant energy efficiency when monitoring information across multiple information streams (e.g., back end server system 104, local branch 105, user device 106, and/or other devices).

At step 203, neuromorphic computing platform 102 may monitor interaction information from one or more sources, such as back end server system 104, local branch 105, and/or user device 106. In some instances, homomorphic encryption may be used to encrypt the interaction information in order to maintain privacy of the interaction information. For example, the interaction information may include information such as communication information, transactional information, interactions between a customer and a service (that a customer has opted into), etc. In some instances, the interaction information may have a source inside or outside enterprise system 110 (via private network 101a or public network 101b). In monitoring the interaction information, neuromorphic computing platform 102 may monitor events corresponding to the interaction information that may be indicative of anomalous activity, such social engineering, phishing, cognitive manipulation, etc.

An example of interaction information may be indicative of anomalous is a phishing attempt directed at user device 106. In this case, a source device, such as malicious device(s) 107 may send a message, such as an email, to a user account associated with user device 106, attempting to gain access to private, confidential information. This type of social engineering attack may be used to access funds associated with the user account. The phishing attempt may be initially detected by neuromorphic computing platform 102 based on the rules that were configured by the spiking neural network at step 202, as discussed in more detail below.

Another example of interaction information that may be indicative of anomalous activity is a large-scale, coordinated increase in loan applications from IP-address linked source devices within a short period of time. This type of activity may be directed to local branch 105, in order to receive unauthorized funds and/or create network congestion. This type of interaction information may be initially detected by neuromorphic computing platform 102 based on the rules that were configured by neural network at step 202, as discussed in more detail below.

Another example of interaction information that may be indicative of anomalous activity may be a distributed denial-of-service (DDoS) attack using fake user accounts attempting to gain access to back end server system 104 by burdening enterprise system 110 and increasing usage of network resources. This type of activity may be directed to back end server system 104, or any devices that send information through back end server system 104. This type of interaction information may be initially detected by neuromorphic computing platform 102 based on the rules that were configured by neural network at step 202, as discussed in more detail below.

At step 204, neuromorphic computing platform 102 may compare interaction information to the rules that were configured as part of the training performed in step 202. For example, a first rule may be based on the previously mentioned phishing attempt. In that instance, the first rule may be comparing an email address of the source of the phishing attempt to an expected email address associated with a request for personal information of the user associated with the account that received the phishing message. If there is no matching email address, then the first rule may be violated, as discussed in more detail at step 205.

As another example, a second rule may be based on the previously mentioned large-scale increase in loan applications from IP-address linked source devices (e.g., by malicious device(s) 107) within a short period of time. In that instance, the second rule may be comparing the IP-addresses of all the source devices, and based on the source devices having matching or partial-mapping IP addresses, the second rule may be triggered. Although described with reference to IP addresses, different rules based on different protocols (e.g., post office protocol (POP), internet message access protocol (IMAP), simple mail transfer protocol (SMTP), and/or other protocols, a security protocol (e.g., secure sockets layer (SSL), transport layer security (TLS), and/or other protocols) may be used without departing from the scope of the disclosure.

As another example, a third rule may be based on the previously mentioned DDoS attack using fake user accounts. In that instances, the third rule may be comparing the time of existence of the fake user accounts to an expected time of existence for a typical real user account. If the time of existence is lower than the expected time of existence for all the fake user accounts, then the rule may be violated, as discussed in more detail below. Although three examples rule are described, fewer or additional rules may be used without departing from the scope of the disclosure (e.g., rules related to analyzing the content of an email for, in some cases, spelling errors, or the like).

Referring to FIG. 2B, at step 205, neuromorphic computing platform 102 may detect one or more rules being violated, based on the comparing performed in step 204. In some instances, neuromorphic computing platform 102 may detect that the one or more rules are violated using the interaction information that neuromorphic computing platform 102 is monitoring in step 203.

For example, based on the previously mentioned first rule, a mismatching email address may cause the first rule to be violated. As another example, based on the previously mentioned second rule, a certain number of matching or partially matching IP addresses may cause the second rule to the violated. As another example, based on the previously mentioned third rule, a certain number of fake user accounts that were recently created may violate the third rule. In some instances, neuromorphic computing platform 102 may utilize one or more neuromorphic processors to compare the interaction information to the rules and/or detect that the rules were violated in parallel, in order for neuromorphic computing platform 102 to operate in real or near real-time.

At step 206, neuromorphic computing platform 102 may compare the one or more rule violations of step 205 to a threshold (or in some cases, multiple thresholds). If the number of rule violations exceeds the threshold then neuromorphic computing platform 102 may proceed to step 207 and trigger a security identification process. If the number of rule violations does not exceed the threshold, then neuromorphic computing platform 102 may continue to monitor interaction information (e.g., proceed to step 203).

In some instances, there may be a threshold that corresponds to a type of rule (e.g., a threshold for the first rule, a threshold for the second rule, and/or a threshold for the third rule). For example, for the first rule (i.e., the phishing attempt), the threshold may be a simple binary option, in which one instance of the first rule being violated may trigger the corresponding threshold. As another example, for the second rule (i.e., large-scale, coordinated increase in loan applications from matching IP addresses), the threshold may be exceeded based on determining that the number of times the second rule has been violated is greater than 100 times within 15 minutes. As another example, for the third rule (DDoS attack from fake user accounts), the threshold may be exceeded based on determining that the number of times the third rule has been violated is greater than 10000 times within 5 minutes. If any corresponding threshold related to any of the rules is exceeded, then neuromorphic computing platform 102 may trigger a security identification process, as discussed in more detail at step 207.

At step 207, neuromorphic computing platform 102 may trigger a security identification process, based on the actions performed at step 206. When neuromorphic computing platform 102 triggers the security identification process, neuromorphic computing platform 102 further analyzes the interaction information to more fully interpret the interaction information, which may subsequently be used to help identify an action to resolve the anomaly associated with the interaction information, as discussed in more detail at step 208. In some instances, if more than one type of interaction information violates one or more rules such that one or more corresponding thresholds is exceeded, then neuromorphic computing platform 102 may use neuromorphic processors to perform the actions described in step 207 in parallel without departing from the scope of the disclosure. In this manner, neuromorphic computing platform 102 can minimize computing resources and minimize energy usage by triggering the security identification process and conducting additional analysis only when certain conditions are met (e.g., one or more thresholds are exceeded).

At step 208, neuromorphic computing platform 102 may identify an action associated with the rule violation(s) that exceeded the threshold and based on the security identification process. For example, an action may be based on first rule violations that exceeded the corresponding threshold. In this case, the action may be to temporarily pause and/or freeze a user account corresponding to user device 106, as discussed in step 212. As another example, an action may be based on second rule violations that exceeded the corresponding threshold. In this case, the action may be to send an alert to the proper team to further investigate and/or resolve the anomalous activity, as discussed in step 210. As another example, an action may be based on third rule violations that exceeded the corresponding threshold. In this case, the action may be to block the devices (i.e., malicious device(s) 107), as discussed in step 211. In some instances, neuromorphic computing platform may identify more than one action based on the security identification process without departing from the scope of the disclosure.

Referring to FIG. 2C, at step 209, neuromorphic computing platform 102 may execute the action that was identified at step 209. For example, a first action may be sending an alert to a proper team best equipped to resolve the anomaly, such as what is shown and described with reference to step 210. As another example, a second action may be blocking malicious device(s) 107, such as what is shown and described with reference to step 211. As another example, a third action may be pausing a user account associated with user device 106, such as what is shown and described with reference to steps 212.

As part of step 209, either of steps 210, 211, and/or 212 may be performed based on the action that was identified at step 208. Although steps 210, 211 and 212 each describe 3 different examples of actions that may be identified and/or executed, more actions may be identified and/or executed. The illustrative examples described herein merely show examples which may be implemented without departing from the scope of the disclosure.

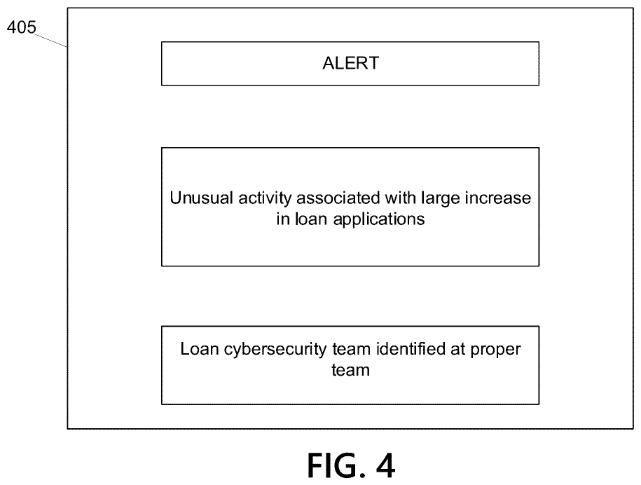

At step 210, neuromorphic computing platform 102 may send an alert to the proper team. For example, the alert may be based on the previously mentioned example related to the coordinated increase in loan applications from IP-address linked source devices in a short period of time. In that instance, a loan cybersecurity team may be identified as the proper team. An example alert may be similar to interface 405 shown by FIG. 4, in which there may be an indication of an alert, an explanation of what gave rise to the alert, the proper team to investigate, and/or other similar information.

At step 211, neuromorphic computing platform 102 may block malicious device(s) 107 related to the anomalous activity. For example, if malicious device(s) 107 are identified as a source of the DDoS attack, then neuromorphic computing platform 102 may send commands to back end server system 104 directing back end server system 104 to disconnect and/or block malicious device(s) from any device within enterprise system 110 (e.g., within private network 101a) and/or devices not within enterprise system 110 (e.g., connected to public network 101b) but still associated with enterprise system 110 (e.g., user device 106 in the case that a user corresponding to user device 106 maintains an account associated with enterprise system 110).

At step 212, neuromorphic computing platform 102 may pause a user account associated with user device 106. For example, if an unauthorized device receives confidential information as a result of a phishing attempt against user device 106, then that user account may be paused so that loss of funds may not occur. After either of steps 216, 219, step 220, or steps 221-222, which each correspond to the type of action that was executed at step 209, neuromorphic computing platform 102 may proceed to step 213 and generate a report.

Referring to FIG. 2D, at step 213, neuromorphic computing platform 102 may generate a report. For example, the report may include information such as the anomaly associated with the interaction information, and/or the action that was identified/executed to resolve the anomaly. In some instances, the report may be similar to what is shown with respect to FIGS. 5A and/or 5B. For example, and with reference to FIG. 5A, interface 505 may show an indication that the identified anomaly was associated with a DDoS attempt, and that the action that was executed to resolve the anomaly was blocking malicious device(s) 107. With reference to FIG. 5B, interface 510 may show an indication that the identified anomaly was associated with a phishing attempt, and that the action that was executed to resolving the anomaly was pausing a user account associated with user device 106. Although not shown, a similar report may be generated and sent based on different anomalies that were detected and corresponding actions that were executed to resolve the anomaly.

In some instances, in generating the report, neuromorphic computing platform 102 may utilize explainable artificial intelligence (XAI) in order to better explain to a human reading the report of the various analysis that neuromorphic computing platform 102 engaged in while performing the functions described herein.

At step 214, neuromorphic computing platform 102 may send the report. For example, neuromorphic computing platform 102 may send the report to enterprise administrative device 108 via communication interface 113 and using the private network 101a. For example, in sending the report, neuromorphic computing platform 102 may additionally send commands, that when received by enterprise administrative device 108, direct enterprise administrative device 108 to display the report.

At step 215, enterprise administrative device 108 may receive the report and the commands directing enterprise administrative device 108 to display the report. For example, enterprise administrative device may receive the report and the commands from neuromorphic computing platform 102 using the private network 101a.

At step 216, based on or in response to the commands directing the enterprise administrative device 108 to display the report, enterprise administrative device 108 may display the report. For example, the display may be similar to what was shown and described with reference to FIGS. 5A and/or 5B.

At step 217, neuromorphic computing platform may dynamically update the spiking neural network, based on the actions performed in 203-212, and/or based on feedback from any of historical database 103, back end server system 104, local branch 105, user device 106, malicious device(s) 107, and/or enterprise administrative device 108. In doing so, neuromorphic computing platform 102 may dynamically and continuously update (e.g., using a dynamic feedback loop) and/or otherwise refine the spiking neural network, so as to increase accuracy of the spiking neural network over time. In some instances, the rules that were previously configured may be modified and/or updated, the thresholds themselves may be modified and/or updated, and/or the actions may be modified and/or updated without departing from the scope of the disclosure.

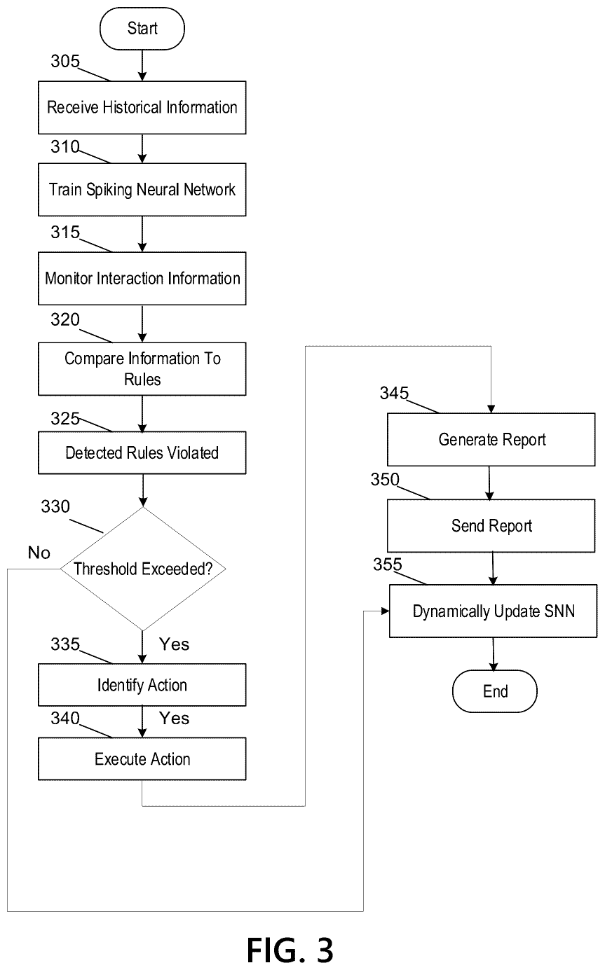

FIG. 3 depicts an illustrative method for identifying and resolving anomalies using neuromorphic computing in accordance with one or more aspects described herein. Referring to FIG. 3, at step 305, a computing platform with at least one processor, a communication interface communicatively coupled to the at least one processor, and memory storing computer-readable instructions may receive historical information (e.g., historical interaction information).

At step 310, the computing platform may use the historical information to train a spiking neural network. At step 315, the computing platform may monitor interaction information associated with one or more devices with an enterprise system 110. At step 320, the computing platform may compare the interaction information to one or more rules that were configured in the training step 310. At step 325, the computing platform may detect that one or more rules are violated.

At step 330, the computing platform may determine whether a threshold associated with the violated rules has been exceeded. If the computing platform determines that the threshold has been exceeded, the computing platform may proceed to step 335. If the computing platform determines that the threshold is not exceeded, the computing platform may proceed to step 355 and dynamically update the spiking neural network.

At step 335, the computing platform may identify an action based on a security identification process. At step 340, the computing platform may execute the action that was identified at step 335. For example the action may correspond to either of the actions that were described with reference to steps 210, 211, and 212 of FIG. 2.

At step 345, the computing platform may generate a report. At step 350, the computing platform may send the report to enterprise administrative device 108. At step 355, the computing platform may dynamically update the spiking neural network.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
train, based on historical information, a machine learning model, wherein training the machine learning model configures the machine learning model to trigger and apply a security identification process;
monitor a plurality of computing devices to detect interaction information;
analyze using a plurality of preconfigured rules of the machine learning model, the interaction information to detect whether or not any of the plurality of preconfigured rules are violated;
based on detecting that one of the plurality of preconfigured rules is violated more than a threshold amount of times, trigger a security identification process of the machine learning model, wherein triggering the security identification process comprises using the machine learning model to identify an action to perform based on the one of the plurality of preconfigured rules and the interaction information; and
execute the action by sending one or more commands, to one or more of the plurality of computing devices, that when received, direct the one or more of the plurality of computing devices to execute the action to address malicious activity associated with the interaction information.

2. The computing platform of claim 1, wherein the machine learning model is a spiking neural network that utilizes one or more neuromorphic processors.

3. The computing platform of claim 1, wherein the one or more preconfigured rules further comprise:
a first rule based on comparing an email address of a source device to an expected email address;
a second rule based on comparing internet protocol (IP) addresses of a plurality of source devices; and
a third rule based on comparing a time of existence of one or more user accounts to an expected time of existence.

4. The computing platform of claim 1, wherein the action further comprises:
identifying a proper team to further analyze an anomaly associated with the interaction information; and
sending an alert to the proper team.

5. The computing platform of claim 1, wherein the action further comprises:
blocking one or more malicious devices associated with the interaction information.

6. The computing platform of claim 1, wherein the action further comprises:
sending commands that direct a user account associated with the interaction information to temporarily pause access to the user account.

7. The computing platform of claim 1, wherein the plurality of computing devices comprises one or more of: a back end server system, a local branch, or a user device.

8. The computing platform of claim 1, wherein the memory stores additional computer-readable instructions that, when executed by the at least one processor, cause the computing platform to:
update, using a dynamic feedback loop and based on the monitoring, the analyzing, and the triggering, the machine learning model.

9. The computing platform of claim 1, wherein the memory stores additional computer-readable instructions that, when executed by the at least one processor, cause the computing platform to:
generate a report, wherein the report comprises the interaction information that caused an anomaly associated with the interaction information, and an action that was executed to resolve the anomaly.

10. The computing platform of claim 9, wherein the memory stores additional computer-readable instructions that, when executed by the at least one processor, cause the computing platform to:
send, to an enterprise administrative device, the report and one or more commands directing the enterprise administrative device to display the report, wherein sending the one or more commands directing the enterprise administrative device to display the report causes the enterprise administrative device to display the report.

11. A method comprising:
at a computing platform comprising at least one processor, a communication interface, and memory:
training, based on historical information, a machine learning model, wherein training the machine learning model configures the machine learning model to trigger and apply a security identification process;
monitoring a plurality of computing devices to detect interaction information;
analyzing using a plurality of preconfigured rules of the machine learning model, the interaction information to detect whether or not any of the plurality of preconfigured rules are violated;
based on detecting that one of the plurality of preconfigured rules is violated more than a threshold amount of times, triggering a security identification process of the machine learning model, wherein triggering the security identification process comprises using the machine learning model to identify an action to perform based on the one of the plurality of preconfigured rules and the interaction information; and
executing the action by sending one or more commands, to one or more of the plurality of computing devices, that when received, direct the one or more of the plurality of computing devices to execute the action to address malicious activity associated with the interaction information.

12. The method of claim 11, wherein the machine learning model is a spiking neural network that utilizes one or more neuromorphic processors.

13. The method of claim 11, wherein the one or more preconfigured rules further comprise:
a first rule based on comparing an email address of a source device to an expected email address;
a second rule based on comparing internet protocol (IP) addresses of a plurality of source devices; and
a third rule based on comparing a time of existence of one or more user accounts to an expected time of existence.

14. The method of claim 11, wherein the action further comprises:
identifying a proper team to further analyze an anomaly associated with the interaction information; and
sending an alert to the proper team.

15. The method of claim 11, wherein the action further comprises:
blocking one or more malicious devices associated with the interaction information.

16. The method of claim 11, wherein the action further comprises:
sending commands that direct a user account associated with the interaction information to temporarily pause access to the user account.

17. The method of claim 11, wherein the plurality of computing devices comprises one or more of: a back end server system, a local branch, or a user device.

18. The method of claim 11, further comprising:
updating, using a dynamic feedback loop and based on the monitoring, the analyzing, and the triggering, the machine learning model.

19. The method of claim 11, further comprising:
generating a report, wherein the report comprises the interaction information that caused an anomaly associated with the interaction information, and an action that was executed to resolve the anomaly; and
sending, to an enterprise administrative device, the report and one or more commands directing the enterprise administrative device to display the report, wherein sending the one or more commands directing the enterprise administrative device to display the report causes the enterprise administrative device to display the report.

20. One or more non-transitory computer-readable media storing instructions that, when executed by a computing platform comprising at least one processor, a communication interface, and memory, cause the computing platform to:
train, based on historical information, a machine learning model, wherein training the machine learning model configures the machine learning model to trigger and apply a security identification process;
monitor a plurality of computing devices to detect interaction information;
analyze using a plurality of preconfigured rules of the machine learning model, the interaction information to detect whether or not any of the plurality of preconfigured rules are violated;
based on detecting that one of the plurality of preconfigured rules is violated more than a threshold amount of times, trigger a security identification process of the machine learning model, wherein triggering the security identification process comprises using the machine learning model to identify an action to perform based on the one of the plurality of preconfigured rules and the interaction information; and
execute the action by sending one or more commands, to one or more of the plurality of computing devices, that when received, direct the one or more of the plurality of computing devices to execute the action to address malicious activity associated with the interaction information.
